(19) United States
(12) Patent Application Publication
(10) Pub. No.: US 2023/0074110 A1
(43) Pub. Date: Mar. 9, 2023

(54) LIQUID PURIFICATION SYSTEM

(71) Applicant: ELECTROPHOR, INC., Woodmere, NY (US)

(72) Inventors: Joseph L. SHMIDT, Woodmere, NY (US); Gleb Dmitrievich RUSINOV, Saint Petersburg (RU); Vadim Nikolaevich KNIZEL, Saint Petersburg (RU)

(21) Appl. No.: 17/798,944

(22) PCT Filed: Feb. 3, 2021
(86) PCT No.: PCT/RU2021/000044

§ 371 Date: Aug. 11, 2022

(30) Foreign Application Priority Data
Mar. 4, 2020 (RU) 2020109574

(51) Int. Cl. B01D 61/08; B01D 61/22; C02F 1/44; C02F 1/68

(52) U.S. Cl. CPC B01D 61/08; B01D 61/22; C02F 1/44; C02F 1/68; B01D 2321/12; B01D 2313/501; B01D 2311/2512

(57) ABSTRACT

A liquid purification system with purified water mineralization, which uses predominantly water from various resources. The main problem of existing liquid purification systems, particularly membrane systems, is that during purification process not only dangerous debris (residual oil, pesticides, herbicides, heavy metals, bacteria, viruses, mechanical particles and other) are removed, but even minerals necessary for human (calcium, potassium, magnesium, sodium and other), so mineralization step is needed after purification step to normalize mineral composition. In the state of the art are known liquid purification systems with integral mineralization means and also devices for mineralization, which can be connected to liquid purification systems. The working principle of systems, known in the state of the art, is that purified liquid flows through the vessel with mineralization additive, which is partly dissolved, and the liquid becomes mineralized. The main drawback of the systems known in the state of the art is that due to peculiarities of the dissolving process and/or mineralization additive content it is impossible to control mineralization process, so the mineralization level is minor, and the pH is higher than the permitted value. Liquid purification system containing raw liquid line, liquid purification unit, mineralization unit, purified liquid line is characterized in that, mineralization of liquid is done by controlled dispensing of mineralization solution, obtained by selective raw or drainage liquids or their mixture.

The invention relates to liquid purification systems with purified water mineralization, which uses predominantly water from various resources.

The main problem of existing liquid purification systems, particularly membrane systems, is that during purification process not only dangerous debris (residual oil, pesticides, herbicides, heavy metals, bacteria, viruses, mechanical particles and other) are removed, but even minerals necessary for human (calcium, potassium, magnesium, sodium and other), so mineralization step is needed after purification step to normalize mineral composition. In the state of the art are known liquid purification systems with integral mineralization means and also devices for mineralization, which can be connected to liquid purification systems. The working principle of systems, known in the state of the art, is that purified liquid flows through the vessel with mineralization additive, which is partly dissolved, and the liquid becomes mineralized. The main drawback of the systems known in the state of the art is that due to peculiarities of the dissolving process and/or mineralization additive content it is impossible to control mineralization process, so the mineralization level is minor, and the pH is higher than the permitted value.

The device for obtaining water enriched with magnesium and potassium of the application US 2011/0100890 [Kinetico Inc, IPC B01D 61/10, published May 5, 2011] is known in the state of the art. The device contains of liquid purification unit, mineralization unit, purified liquid storage vessel and purified liquid supply for consumption means. All elements of the system US 2011/0100890 are connected in series. Mineralization unit consists of mixture of potassium and calcium containing components and means for working media retention. These means are ranged in mineralization unit in the water inlet and outlet and between potassium and calcium containing components. Device of an application US 2011/0100890 works as follows: raw liquid flows into the inlet of the liquid purification unit, after purification liquid goes through mineralization unit and then into collecting vessel for the purified liquid, from where it flows to the consumer if necessary. The drawback of the invention of the application US 2011/0100890 A1 is that within time mineralization component particles accumulate on the surface or inside of retention means, hence the resistance of liquid which flows into the collecting vessel is increased, and this leads to carrying power decrease of the mineralization unit. In addition, the mineralization process depends on the amount of potassium and calcium containing components, so the mineralization degree within durability will be different.

The liquid mineralization device of a patent U.S. Pat. No. 7,303,666 B1 [SpectraPure Inc, IPC B01D 29/62, 29/50, 63/00, 61/00 pub. Apr. 12, 2007] is known in the state of the art. The device of a patent U.S. Pat. No. 7,303,666 consists of raw liquid line, liquid purification unit, mineralizer made as body, filled with mineralization agent, purified liquid collecting vessel, which is connected through liquid return line to liquid purification unit inlet, and is connected through purified liquid supply line to mineralizer liquid outlet. Non-return valves are installed on the liquid return line and purified liquid supply line. System of a patent U.S. Pat. No. 7,303,666 B1 works as follows. Raw liquid from the source of the raw liquid along raw liquid line flows into liquid purification unit, where liquid purification process takes place. Purified liquid flows through mineralizer and then goes for consumption or liquid flows through purified liquid supply line into collecting vessel, which is filled with purified liquid till the pressure reaches the predetermined level, then the system stops. The drawback of the system is that there is no means to control liquid mineralization process. The mineralization level depends on liquid flow velocity, liquid temperature, ambient temperature, and other factors, which influence on the solution process. In addition, mineralization process depends on amount of mineralization component, so the mineralization level within durability will be different.

Liquid purification and mineralization system of a patent RU 2515317 [Aquaphor Corp., IPC B01D 61/10, B01D 15/00, B01D 25/00, published Oct. 5, 2014], which is chosen as the closest analogue is known in the state of the art, System of a patent RU 2515317 consists of raw liquid line, liquid purification unit, liquid supply line with the valve, mineralization unit, made as the body, filled with mineralization composition, «back and forth» supply line, collecting vessel and purified liquid line. Raw liquid line is connected to the liquid purification unit inlet; liquid purification unit outlet through supply liquid line with the valve is connected to mineralization unit. The valve on the supply liquid line with the valve is arranged so that liquid can flow from liquid purification unit to the valve only in one direction, liquid from the valve to liquid mineralization unit can flow in two directions. Mineralization unit from one side is connected to liquid supply line with the valve and from other side is connected to the collecting vessel through the line «back and forth». The purified liquid inlet is connected to the valve of the liquid supply line with the valve. The system of a patent RU 2515317 works as follows: raw liquid alone raw liquid line flows into the liquid purification unit, where liquid purification takes place. Purified liquid along liquid supply line with the valve goes into mineralization unit, where first step of mineralization is done. Then the liquid along “back and forth” supply line flows into collecting vessel. If it is necessary liquid flows from collecting vessel along “back and forth” supply line into mineralization unit, where second step of mineralization is done. From mineralization unit along liquid supply line with the valve liquid flows into the purified liquid line and then for the consumption. The drawback of indicated system is that mineralization liquid process is based on the mineralization composition dissolving. The process is uneven, uncontrolled and depends on liquid flow velocity, liquid temperature and ambient temperature. Also, liquid flows through mineralization unit two times, such uncontrolled process is done twice, and the mineralization level can be either insufficient or excessive. And mineralization process depends on the amount of mineralization component, so the mineralization level within durability will be different. But the main drawback of the system, chosen as the closest analogue is its complexity as there are several elements through which liquid flows in two directions, it demands complex control unit of liquid flows. This fact decreases the reliability of the system.

The object of the invention and the attained technical effect is to develop new liquid purification system with controlled and even liquid mineralization during all durability and to increase the reliability and simplify the construction.

Problem to be solved and achieved technical result is that the liquid purification system containing raw liquid line, liquid purification unit, mineralization unit, purified liquid line is characterized in that, mineralization of liquid is done by controlled dispensing of mineralization solution, obtained by selective raw or drainage liquids or their mixture, and mineralization unit consists of concentrate supply line, selective treatment element, mineralization component supply line, mineralization solution dispenser, and concentrate supply line inlet is connected with drainage liquid outlet of liquid purification unit and/or raw liquid line, concentrate supply line outlet is connected to selective treatment element inlet, the outlet of selective treatment element is connected to mineralization solution supply line, which inlet through mineralization solution dispenser is connected to purified liquid line; where selective treatment element consists of not less than one hollow fiber membrane and not less than one sorption purification element, and may additionally contain mineralization additive; and additionally the system may contain control panel, functionally connected to mineralization solution dispenser and at least one sensor, which can be installed on raw liquid line and/or purified liquid line and/or mineralization solution supply line.

Figures depicts disclosure of invention:

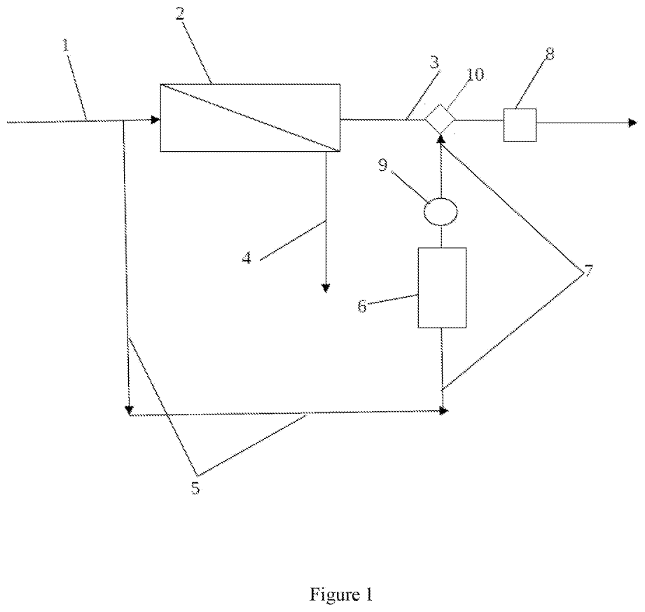

FIG. 1—general schematic diagram of the liquid purification system, where concentrate supply line (6) inlet is connected to raw liquid line (1);

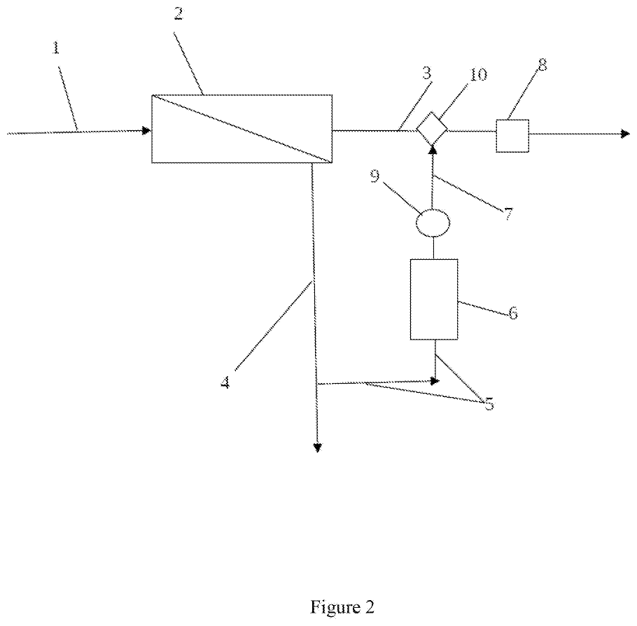

FIG. 2—general schematic diagram of the liquid purification system, where concentrate supply line (6) inlet is connected to drainage liquid outlet of liquid purification unit (2);

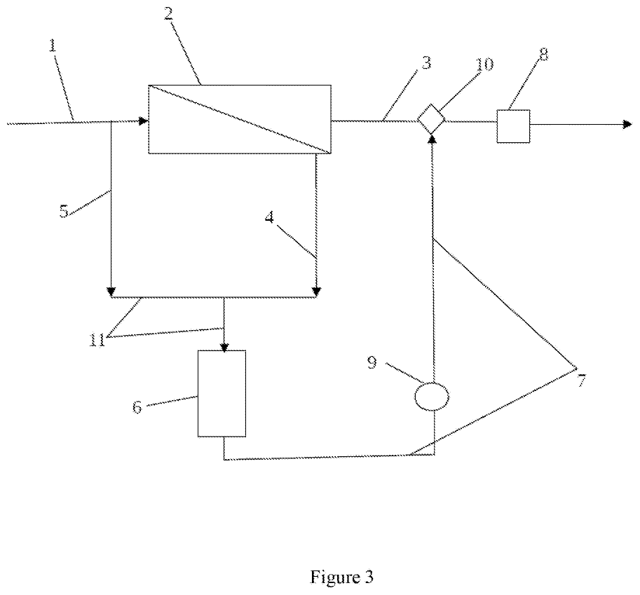

FIG. 3—general schematic diagram of the liquid purification system, where concentrate supply line (6) inlet is connected to drainage liquid outlet of liquid purification unit (2) and raw liquid line (1);

Liquid purification system (FIG. 1-3) in general consists of raw liquid line (1), liquid purification unit (2) purified liquid line (3) and mineralization unit (4).

Inlet of raw liquid line (1) is connected to raw liquid source; raw liquid line (1) outlet is connected to liquid purification unit (2) inlet. Raw liquid line (1) may additionally contain pressure increasing means (not depicted on the figure), for example, pump or pump system. Raw liquid line (1) may additionally contain raw liquid vessel (not depicted on the figures): Raw liquid line (1) may additionally contain pressure reducer (not depicted on the figures). Raw liquid line (1) may additionally contain fluid control valve (not depicted on the figures). Raw liquid line (1) may additionally contain sensor (not depicted on the figures), made as salt content measuring means, for example TDS-sensor, or as liquid conduction measuring means, or as ion selective electrode or a sensor or a combination of ion selective electrode or a sensor.

Liquid purification unit (2) through its inlet is connected, to raw liquid line (1), and threw outlet is connected to purified liquid line (3). In general liquid purification unit (2) consists of at least one liquid purification membrane element (5). Liquid purification membrane element (5) may be made as reverse osmosis membrane or ultrafiltration or microfiltration hollow fiber membrane. Liquid purification unit (2) may contain two or more liquid purification membrane elements (5), which may be installed either in series or in parallel. Additionally liquid purification unit (2) may contain mechanical pre-filters, sorption pre-filters, water conditioning cartridges, water softening cartridges (not shown on the figures). In case membrane liquid purification element (5) is made as reverse osmosis membrane liquid purification unit (2) has drainage liquid outlet. Liquid purification unit (2) may additionally contain flushing unit (not depicted on the figures), and in this case liquid purification unit (2) has drainage liquid outlet too. Liquid purification unit (2) may additionally contain drainage liquid line (10), connected to drainage liquid outlet. Drainage liquid may partly flow into mineralization unit (4), and partly is drawn out of the system through drainage liquid discharge line (10). Liquid purification unit (2) may additionally contain recirculation line (not shown on the figures). Inlet of recirculation line is connected to drainage liquid outlet; the outlet is connected to raw liquid inlet of liquid purification unit (2) or to membrane liquid purification element inlet (5) Liquid purification elements and/or valve systems to regulate liquid recirculation level (not shown on the figures) may be additionally installed on recirculation line. Liquid purification unit (2) may additionally contain at least one collecting vessel (not shown on the figures).

Inlet of purified liquid line (3) is connected to liquid purification unit (2) outlet, purified liquid line (3) is intended for purified liquid consumption. Purified liquid line (3) may be additionally equipped with liquid consumption means (not shown on the figures), such as faucet or a valve. Additionally purified liquid line may contain one or more collecting vessels of different type (not shown on the figures). Additionally purified liquid line may contain a valve (not shown on the figures), made as salt content measuring means, for example, TDS-sensor, or as liquid conduction measuring means, or as ion selective electrode or a sensor or a combination of ion selective electrode or a sensors.

Mineralization unit (4) consists of concentrate supply line (6), selective treatment element (7), mineralization solution supply line (8), mineralization solution dispenser (9). Concentrate supply line (6) inlet is connected to raw liquid line (1) (FIG. 1). Or concentrate supply line (6) inlet is connected to drainage liquid outlet of liquid purification unit (2) (FIG. 2). Or concentrate supply line (6) inlet is simultaneously connected to raw liquid line (1) and drainage liquid outlet of liquid purification unit (2) (FIG. 3). Concentrate supply line (6) outlet is connected to selective treatment element (7) inlet, the outlet of which is connected to mineralization solution supply line (8), the outlet of which through mineralization solution dispensing means (9) is connected to purified liquid line (3). Additionally, mineralization unit (4) is connected to the collecting vessel (not shown on the figures).

Selective treatment element (7) consists of not less than one hollow fiber membrane and not less than one sorption treatment element, installed one by one. The order in sequence down liquid flow from inlet to outlet of selective treatment element (7) may be different. For example, but not limited to, sorption treatment element can be installed first and then hollow fiber membrane of vice versa. Or there can be two sorption treatment element s and hollow fiber membrane between them. Parts of selective treatment element (7) can be made each in separate bode or several parts in one body. Hollow fiber membrane may be ultra or microfiltration membrane. Sorption treatment element may be made as, for example, but not limited to mixture of granulated or fibrous sorbents or as carbonblock, or carbfiberblock, or nonwoven sorption material or multilayer sorption material. Selective treatment element (7) may additionally contain mineralization additive. Selective treatment element (7) extracts organic debris from the liquid (residual oil, pesticides, herbicides, trace quantities of pharmaceuticals, heavy metals, mechanical impurities, viruses and bacteria), bit leaves the healthful minerals in the water.

Supply mineralization solution line (8) may additionally contain a sensor (not shown on the figures), made as salt content measuring means, for example TDS-sensor, or as liquid conduction measuring means, or as ion selective electrode or a sensor or a combination of ion selective electrode or a sensor.

Mineralization solution dispenser (9) may be made as, for example, but not limited to, as mechanical, electromechanical, electrical (servo-motor) valve or dosing pump. Mineralization solution dispenser (9) permits in manual or auto mode to regulate the frequency and volume of dispensing mineralization solution into the purified liquid. Dispensing may be either continuous with predetermined rate, or batch in pulse mode.

Liquid purification system may additionally contain control panel (not shown on the figures), which functionally is connected mineralization solution dispenser (9). So, if additional sensors are installed on raw liquid line (1) and/or purified liquid line (3), and/or on mineralization solution supply line (8) they are too connected with control panel, and it is possible to set and correct the mineralization solution dosing on the base of sensors values.

Within distinguishing features, the claimed system works as follows. Raw liquid from its source along raw liquid line (1) goes into liquid purification unit (2), where purification takes place. Purified liquid flows into purified liquid line (3). At the same time raw liquid from the raw liquid line (1) and/or drainage liquid from liquid purification unit (2) goes into mineralization unit (4), where along concentrate supply line (6) flows into the selective treatment element (7) inlet, where selective purification of concentrate takes place and the mineralization solution is formed. Mineralization solution along mineralization-solution supply line (8) through mineralization solution dispenser (9) is dosed under control into purified liquid on the purified liquid line (3). Purified mineralized liquid goes to the consumption.

In the system of the closest analogue, the base of mineralization process is the mineralization composition dissolution. This process depends on different factors and is difficult to control. In the claimed invention the base of mineralization process is fluidic dispensing principle which can easily regulated. So, opposed to the closest analogue the system provides for controlled mineralization. The mineralization solution is formed during liquid purification process, so the system does not require additional vessels for mineralization solution prepared beforehand, which eases its operation. In addition, opposed to the closes analogue the system does not need elements where liquid flows “back and forth”, which increases the system reliability. Also opposed to the closest analogue system working efficiency is achieved with only one mineralization solution dispenser and there is no need in complicated valve system which also increases the reliability of the system.

The description of the present invention submits a preferred embodiment of the invention. It can be changed within the claimed set of the claims, so the wide use of the invention is possible.

We claim as follows:

1. A liquid purification system comprising:
a raw liquid line;
a liquid purification unit;
a mineralization unit; and
a purified liquid line, characterized in that, mineralization of liquid is done by controlled dispensing of mineralization solution, obtained by selective raw or drainage liquids or their mixture.

2. The liquid purification system according to claim 1, characterized in that the mineralization unit comprises a concentrate supply line, a liquid selective treatment element, a mineralization component supply line, a mineralization solution dispenser, and a concentrate supply line inlet which is connected with a drainage liquid outlet of the liquid purification unit and/or the raw liquid line, wherein a concentrate supply line outlet is connected to a selective treatment element inlet, wherein an outlet of the selective treatment element is connected to a mineralization solution supply line, which inlet through the mineralization solution dispenser is connected to the purified liquid line.

3. Liquid purification system according to claim 2, characterized in that the liquid selective treatment element comprises at least one hollow fiber membrane and at least one sorption purification element.

4. Liquid purification system according to claim 2, characterized in that the liquid selective treatment element comprises a mineralization additive.

5. Liquid purification system according to claim 1, further comprising a control panel functionally connected to a mineralization solution dispenser.

6. Liquid purification system according to claim 1, further comprising at least one sensor installed on at least one of the raw liquid line, the purified liquid line and the mineralization solution supply line.
